(19) United States
(12) Patent Application Publication
(10) Pub. No.: US 2010/0102591 A1
(43) Pub. Date: Apr. 29, 2010

(54) Sliding, Toollessly Removable Side Window

(75) Inventors: F. C. Maynard, Nashville, TN (US); Clifford L. Wilkinson, Cottontown, TN (US)

Correspondence Address: PITTS AND BRITTIAN P C, P O BOX 51295, KNOXVILLE, TN, 37950-1295, US

(73) Assignee: J-Dak, Inc., Springfield, TN (US)

(21) Appl. No.: 12/260,648

(22) Filed: Oct. 29, 2008

(51) Int. Cl. E06B 3/42; B23P 19/04

(52) U.S. Cl. 296/155; 29/426.1

(57) ABSTRACT

A sliding, toollessly removable side window for an Off-Highway or On-Highway vehicle includes a spring-back frame fixed to a longitudinal side of the vehicle which comprises a main frame and sub-frame joined by a corner bracket assembly and a spring loaded frame release latch where the latch is used to open and close the spring-back frame, a first pane installed in the spring-back frame where when the frame is opened the first pane can easily be removed for cleaning, etc., a second pane slidably mounted in the spring-back frame on a main frame guide rail assembly, a duck bill latch attached to the second pane which is adapted to release the second pane from a locked position in the main frame to be opened or closed by the operator where a guide mechanism is provided to guide the second pane the operator slides it to an open or closed position.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The invention relates to a sliding, toollessly removable side window for On-Highway and Off-Highway vehicles. More particularly, this invention pertains to an improved sliding, toollessly removable side window assembly mounted in the sides of On-Highway and Off-Highway vehicles which is unique in design comprising two panes installed in a spring-back frame which allows for easy and quick removal of the panes from the vehicle by the operator or user for cleaning, replacing, or other related purposes.

2. Description of the Related Art

Specialty Equipment such as On-Highway and Off-Highway vehicles are used for construction, mining, farming, landscaping, and other related activities, have openings on the sides to provide the operator of the vehicles with an extended view of his or her surroundings and other vehicles for safer use of the vehicle. As more of these On-Highway and Off-Highway vehicles (i.e. Construction and Agricultural Equipment such as Bobcat Skid Loaders, etc., Fire Trucks, Specialty Vehicles and Military Vehicles) are equipped with HVAC systems, side windows are needed to enclose these side openings to maintain climate control within the cab of the vehicle and to protect the operator from inclement weather conditions. However, these vehicles are often used in dusty or adverse environments which cause the panes in the windows to become dirty, thereby reducing the operator's visibility. Therefore, in order to keep a clear visible line of sight, the operator often needs to clean the panes to remove any such debris, dirt, or other foreign matter. Moreover, from time to time the windows also need to be replaced as they are permanently damaged or broken; therefore, a need exists for an easy, quick method to remove and replace the windows.

Currently, removing the panes from side windows mounted on such On-Highway and Off-Highway vehicles requires the use of various tools and is a cumbersome, time consuming process for the operator. Specifically, the side windows in the prior art are hingedly attached to On-Highway and Off-Highway vehicles thereby requiring several steps for the operator to open the frame and remove the panes for cleaning, replacement or for other related purposes. In addition, such a design creates an increased risk of breaking the pane during the removal process because the pane is not designed to stay intact as it is being removed; therefore, in many cases the pane falls and is permanently damaged or broken. Therefore, a need exists for a sliding, toollessly removable side window that permits the panes to be easily removed by the operator of the vehicle with minimal use of any tools, where the pane remains intact during the removal process until it is removed by the operator and after the pane is installed and re-installed when cleaned, replaced, etc., a water-tight seal along its edges and the edges of the frame in the vehicle is maintained.

### BRIEF SUMMARY OF THE INVENTION

The present invention relates to a sliding, toollessly removable side window for an Off-Highway or On-Highway vehicle designed to provide an extended outside view for the operator where the windows are easily and quickly removed for cleaning, replacement or other related purposes as needed using a minimal amount of tools, if any. The sliding, toollessly removable side window comprises a spring-back frame assembly formed in a unique shape adapted to mount onto the side of an Off-Highway and On-Highway vehicle (i.e., vehicle used in construction, farming, landscaping or other such related activities such as a Bobcat skid loader, etc.) comprising a main frame and sub-frame assembly joined by a corner bracket assembly and a spring loaded frame release latch with a first pane and second pane installed where the first pane remains stationary during use of the vehicle and the second pane is slidably mounted so that it is capable of being opened or closed using a multi-positionable latch and guide mechanism attached to the side of the pane.

As stated above, the spring-back frame assembly includes a main frame and sub-frame assembly. The main frame and sub-frame assemblies are constructed from extrusions which are individually formed in unique shapes having an external and internal channel member with external and internal guide slots where the internal guide slots are adapted to secure the first and second pane in the spring-back frame. The main frame and sub-frame assemblies are joined by the corner bracket assembly and the spring loaded frame release latch to allow the opening and closing of the spring-back frame assembly where the first and second pane can be easily and quickly removed by the operator. The corner bracket assembly includes a corner bracket which is positioned in the exterior guide slot between the adjacent edges of the shorter vertical side of the main frame and the bottom side of the sub-frame and is fastened to both the main frame and sub-frame with a miter gasket between the adjacent edges of the frames providing a water-tight seal. In addition, a spring loaded frame release latch is positioned in the exterior guide slot of the top side of the sub-frame wherein the body of the latch extends to the exterior guide slot of the main frame securing the sub-frame assembly to the main frame assembly. As joined, the main frame and sub-frame assemblies form the spring back frame assembly which, as stated above, is adapted to hold a first and second pane.

In the present embodiment, the first and second panes are panels or sheets of glass having outer and inner surfaces and are formed in predetermined unique geometric shapes adapted to cover the openings in the spring-back frame assembly. The first pane is installed in the spring back frame assembly in a stationary manner where the pane can resist movement due to shock and vibration when the vehicle is in use. The second pane is slidably mounted in the spring back frame assembly where a main frame guide assembly is attached to the internal channel member of the bottom side of the main frame to which the second pane is mounted allowing the pane to slide in a longitudinal direction. In addition, a multi-positionable latch and guide mechanism are attached to the side of the second pane where the operator can open or close the second pane using a multi-positionable latch.

The panes in the present invention can be removed by opening the spring back frame and removing the panes accordingly. To open the spring-back frame, the operator slides the spring loaded frame release latch using the frame latch lever moving the body of the latch out of the main frame external guide slot thereby releasing the main frame assembly from the sub-frame assembly. After the main frame assembly is released from the sub-frame assembly, the operator uses a lift plate attached to the top side of the main frame to lift the main frame assembly up and off the first pane allowing the easy removal of the pane for cleaning, replacing or other related purposes. The second pane is removed by sliding the pane in the fully open position and also using the lift plate to lift the main frame assembly up and off of the second pane permitting the easy removal of the pane for cleaning, replacing or other related purposes.

Accordingly, the present invention provides a sliding, toollessly removable side window for Off-Highway or On-Highway vehicle that can be easily maintained by the operator through the use of the spring back frame assembly which allows for the quick and easy removal of the panes from the sliding, toollessly removable side window to be cleaned, replaced, and other related purposes.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of one embodiment of a sliding, toollessly removable side window assembly of the present invention mounted along a longitudinal side of an Off-Highway and On-Highway vehicle used in construction, farming, etc.; and

FIG. 2 is an outside view of the left-hand side sliding, toollessly removable side window assembly depicted in FIG. 1; and

FIG. 3 is an inside view of the left-hand side sliding, toollessly removable side window assembly depicted in FIG. 1; and

FIG. 3a is a cross sectional view of the sliding, toollessly removable side window assembly with the first and second panes installed; and

FIG. 3b is a cross sectional view of the sliding, toollessly removable side window assembly where the lift plate is attached to the top side of the exterior guide slot of the main frame assembly; and

FIG. 3c is a cross sectional view of the sliding, toollessly removable side window assembly illustrating the first pane as installed in the sliding, toollessly removable side window; and

FIG. 3d is a cross sectional view of the sliding, toollessly removable side window assembly showing the second pane as installed onto the main frame bottom rail assembly in the sliding, toollessly removable side window; and

FIG. 3e is a cross sectional view of the sliding, toollessly removable side window where the guide mechanism is attached to the second pane with the upper inside guide rail of the main frame assembly; and

FIG. 4 is an inside view of the main frame assembly; and

FIG. 4a is a cross sectional view of the main frame assembly on the bottom side of the main frame through a weep hole; and

FIG. 4b is a cross sectional view of the main frame assembly on the top side of the main frame through the guide slot; and

FIG. 4c is a cross sectional view of the main frame assembly; and

FIG. 5 is an inside view of the sub-frame assembly; and

FIG. 5a is a top view of the spring loaded frame release latch as mounted to the sub-frame assembly; and

FIG. 5b is a side view of the spring loaded frame release latch as mounted to the sub-frame assembly; and

FIG. 5c is a cross sectional view of the sub-frame assembly; and

FIG. 6 is an inside view of the main frame extrusion; and

FIG. 6a is an inside view of the sub-frame extrusion; and

FIG. 7 is an inside view of the spring-back frame;

FIG. 7a is a detailed view of the corner bracket assembly joining the main frame and sub-frame assembly; and

FIG. 7b is a cross sectional view of the spring-back frame assembly illustrating the corner bracket assembly joining the main frame and sub-frame assembly; and

FIG. 8 is a side view of the first pane assembly; and

FIG. 8a is a cross sectional view of the first pane assembly; and

FIG. 8b is a detailed view of the stop pawl attached to the first pane assembly; and

FIG. 9 is a side view of the second pane assembly; and

FIG. 9a is a cross sectional view of the first pane assembly; and

FIG. 9b is a detailed view of the stop pawl attached to the second pane assembly depicted in FIG. 9; and

FIG. 10 is a side view of the main frame bottom rail assembly; and

FIG. 11 is a side view of the main frame bottom rail assembly; and

FIG. 11a is a cross-sectional view of the main frame bottom rail assembly; and

FIG. 12 is a top view of the main frame bottom rail assembly.

### DETAILED DESCRIPTION OF THE INVENTION

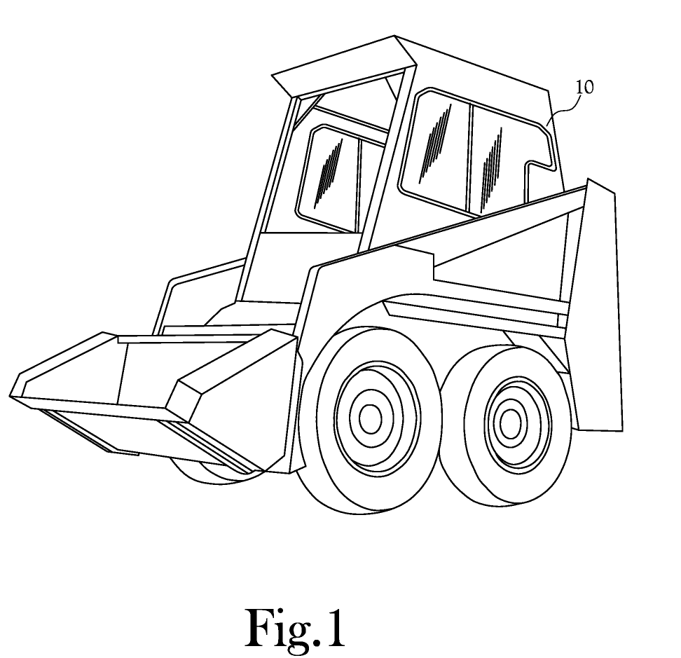

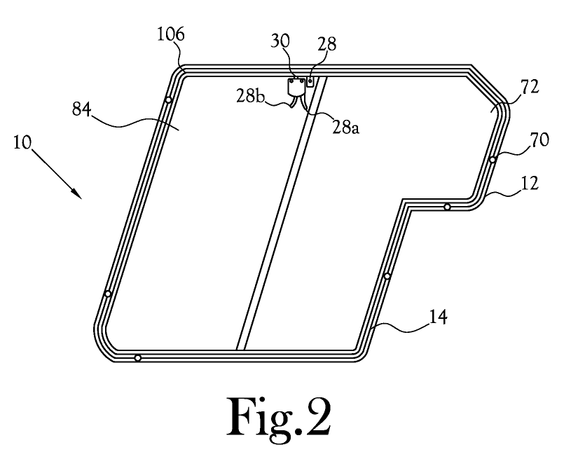

In this disclosure it should be noted that the term “inside” is intended to define the side of the component which faces inward toward the passenger compartment. Moreover, the term “outside” is used in this disclosure to define the side of the component that faces outward and forms part of the outer surface of the vehicle. In addition, for purposes of this disclosure it should be noted that the sliding, toollessly removable side window shown in the FIGS. 1-3, and described below is for a left-hand side window; however, it is noted that the scope of this invention also extends to the right-hand side window which is essentially the same as the left-hand side in that it is only an inverted form of the same.

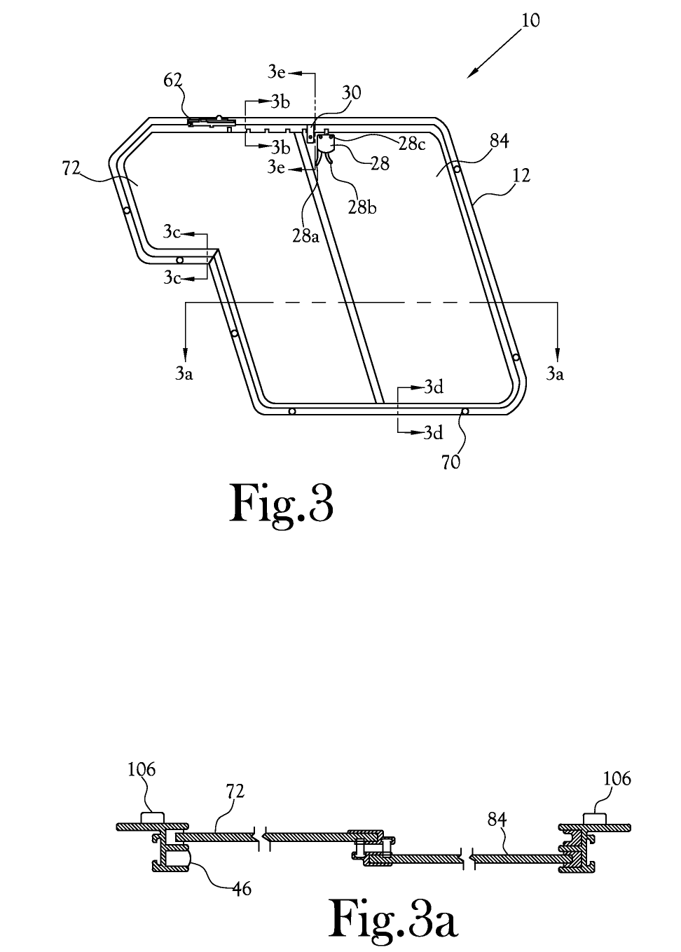

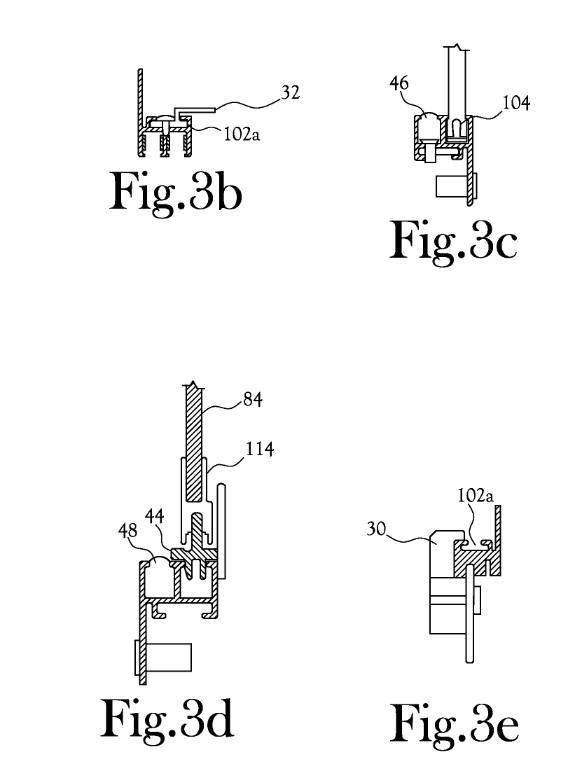

FIGS. 1-3 illustrate a sliding, toollessly removable side window assembly mounted to the side of an Off-Highway and On-Highway vehicle used in construction, farming, etc., according to the present invention. The sliding, toollessly removable side window assembly is identified as 10 herein and in the accompanying FIGS. 1-3. As referenced in FIGS. 1-3, the sliding, toollessly removable side window assembly 10 comprises a spring-back frame assembly 12 formed in an unique shape having a first pane 72 and second pane 84 installed where the first pane 72 is mounted to the spring-back frame assembly 12 in a stationary manner and the second pane 84 is slidably mounted to the frame assembly 12 thereby permitting the pane 84 to move in a longitudinal direction. As shown in FIGS. 3, 3d and 3e a rubber stop 48 is attached to the spring-back frame assembly securing the first pane 72 in a stationary manner and a latch 28 and guide mechanism 30 are attached to the second pane 84 allowing the operator to move the pane 84 in a longitudinal direction as desired.

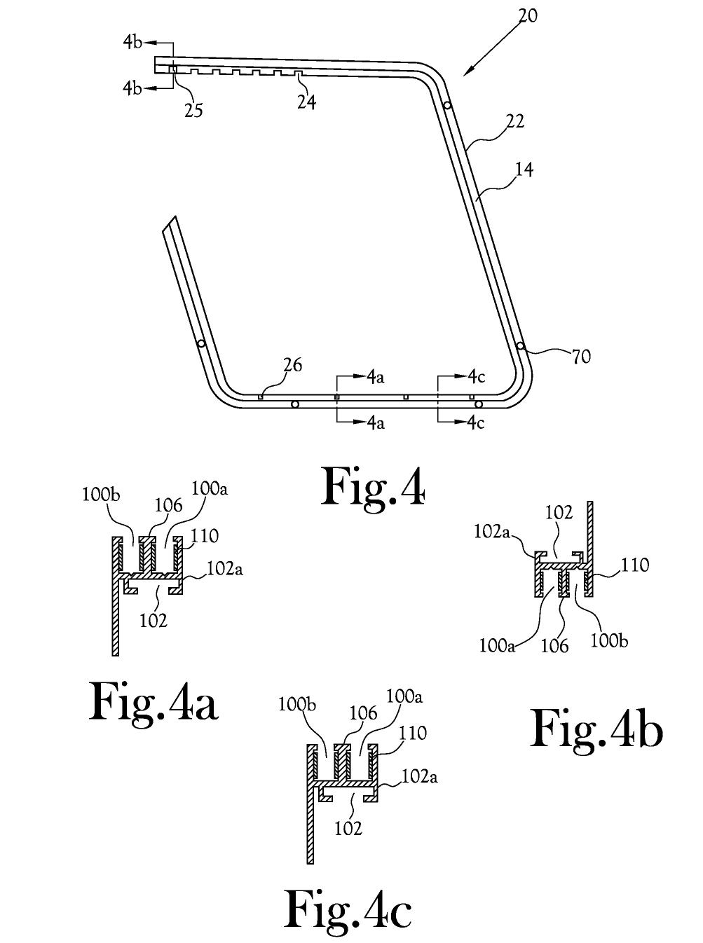

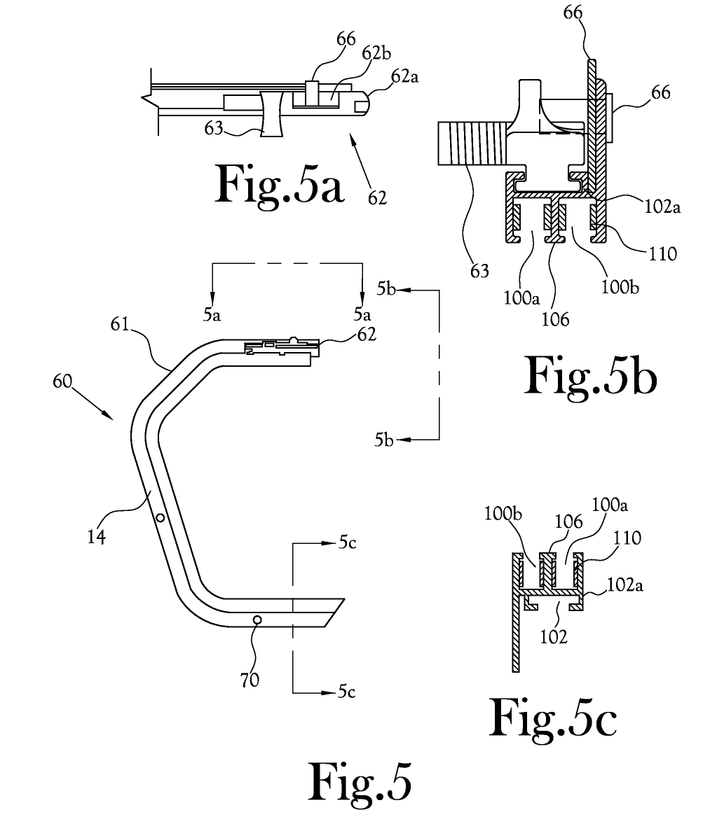

In the present invention, the spring-back frame assembly 12 of the sliding, toollessly removable side window 10 comprises a main frame assembly 20 and a sub-frame assembly 60 which are individually formed in unique shapes by extrusions 22 and 61, as shown in FIGS. 4-6, and in one embodiment are preferably constructed of AL6063, T-52 with black polymer coating. The extrusions 22 and 61 and have an outer flange 14 extending around the perimeter of the spring-back frame assembly 12 wherein a plurality of threaded holes 70 are located along the perimeter of the frame assembly 20 on the outer flange 14 where the sliding, toollessly removable side window assembly 10 is fastened to the longitudinal side of the Off-Highway and On-Highway vehicle. In addition, a foam tape seal 63 as shown in FIG. 3a is attached to the outside perimeter of the spring-back frame assembly 12 along the outer flange providing a water tight seal between the sliding, toollessly removable side window 10 and the longitudinal side of the vehicle when mounted to the vehicle. The main frame and sub-frame extrusions 22 and 61 also have an external channel member 102 with a exterior guide slot 102a extending along the external perimeter of the main frame 22 and sub-frame 61 and an internal channel member 100 with a first interior guide slot 100a and a second interior guide slot 100b that are separated by an internal guide rail 106 and are lined along each side with strips of felt 110 as shown in FIGS. 4a, 4b, 4c, 5b and 5c.

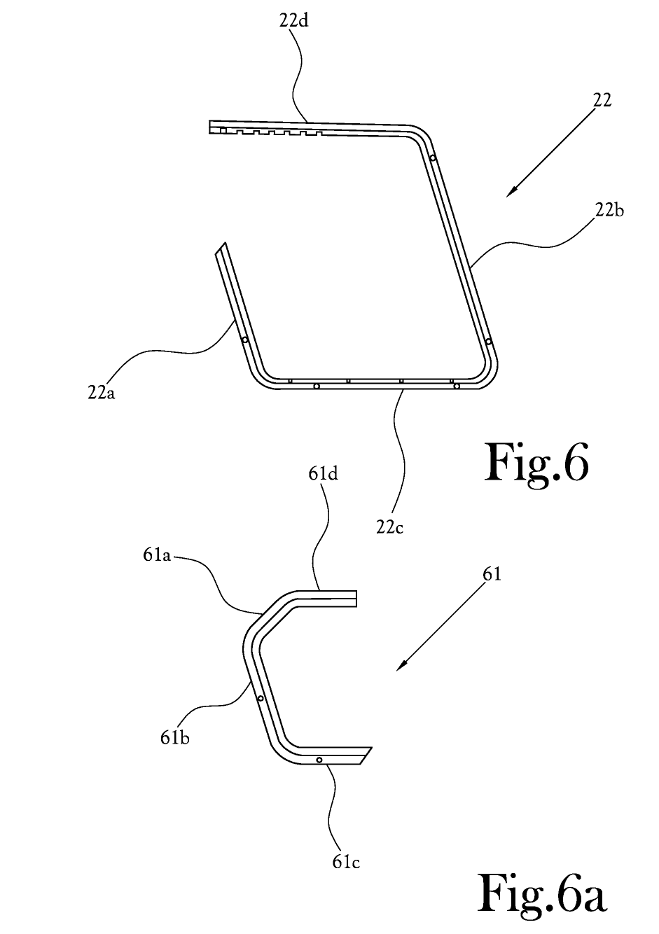

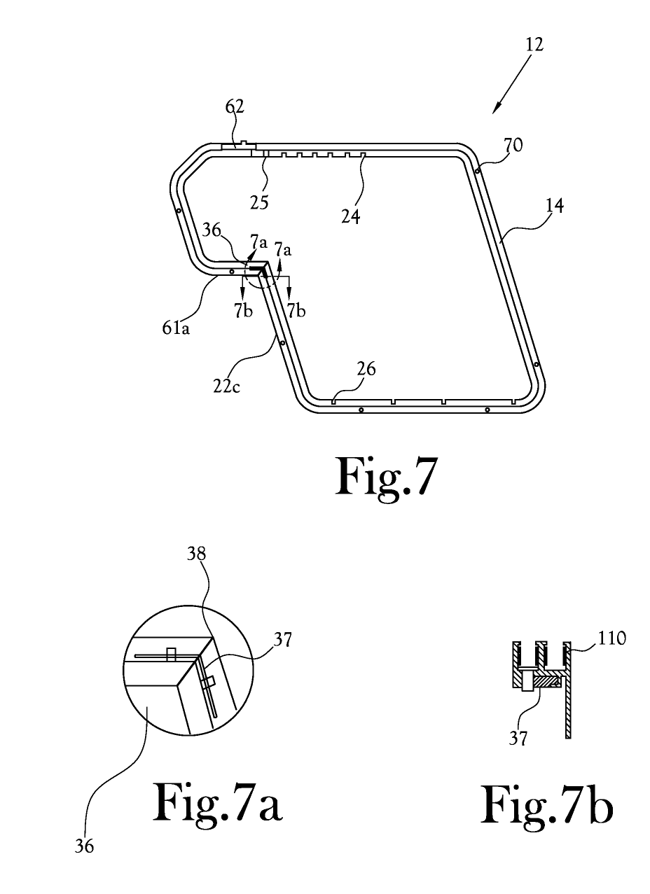

As stated above, the main frame assembly 20 and sub-frame assembly 60 are unique in shape and formed by extrusions 22 and 61. The main frame extrusion 22 has a plurality of sides which include at least a shorter vertical side, longer vertical side, bottom side and top side 22a, 22b, 22c and 22d as shown in FIG. 6. The sub-frame extrusion also includes a plurality of sides which include at least a top side, bottom side, longer and shorter side 61a, 61b, 61c and 61d, respectively as shown in FIG. 6a. The main frame assembly 22 and sub-frame assembly 60 are joined by a corner bracket assembly 36 and a spring-loaded frame release latch 62. As shown in FIGS. 7, 7a and 7b, the corner bracket assembly 36 includes a corner bracket 37 which is positioned onto the exterior guide slot 102a between the shorter vertical side of the main frame 22c and the lower bottom side of the sub-frame 61a where a miter gasket 38 is placed between the main frame and sub-frame extrusions 22 and 61 and the corner bracket 37 is fastened to the main frame 20 and sub-frame 60 by the insertion of screws into a pre-drilled silicone lined holes.

As stated, the main frame assembly 22 and sub-frame assembly 60 are also joined along the top side of the main frame and sub-frame by a spring loaded frame release latch 62. As illustrated in FIGS. 5, 5a, and 5b the spring loaded frame release latch 62 is positioned in the exterior guide slot 102a of the top side of the sub-frame 61b parallel to a retainer plate 64 with an installed rivet nut 66 mounted to the inside of the top side of the sub-frame 61b where the rivet nut 66 is adapted to fit inside the frame release latch exterior guide channel 62b. In use, the body 62a of the spring loaded frame release latch 62 extends into the external guide slot 102a of the top side of the main frame and a frame release latch lever 63 extends to the inside of the passenger compartment of the vehicle providing a mechanism for sliding the body 62a of the frame release latch 62 in and out of the guide slot 102a of the top side of the main frame. The main frame assembly and sub-frame assembly are joined when the body 62a of the frame release latch 62 is extended into the exterior guide slot 102a of the top side of the main frame. When joined as described above, the main frame and sub-frame assemblies form the spring back frame assembly which is adapted to hold the first and second pane 72 and 84.

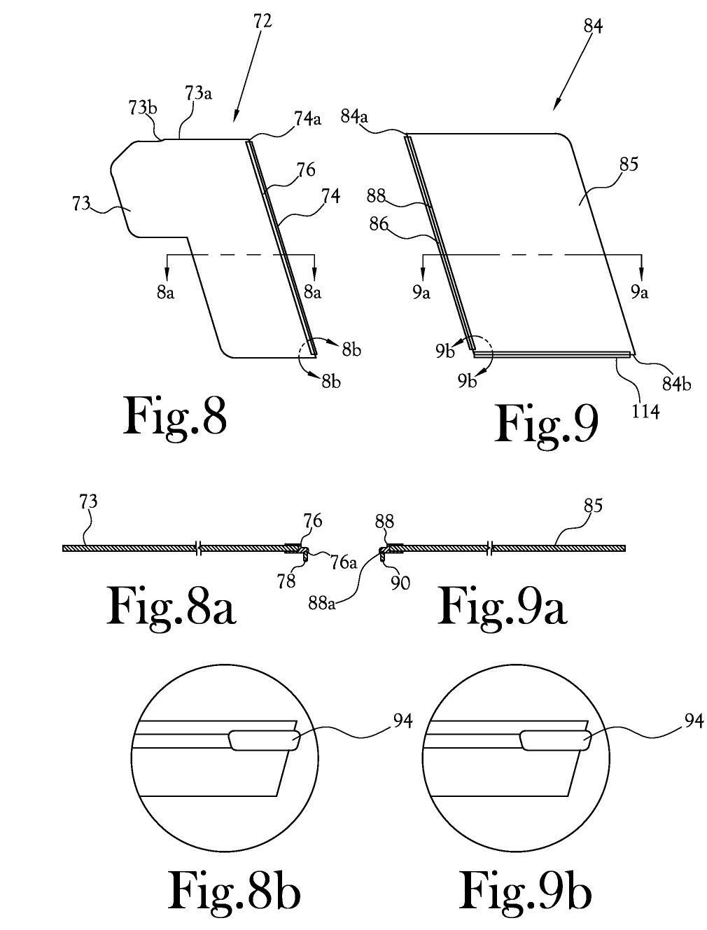

The first and second panes 72 and 84 depicted in FIGS. 8 and 9, include a panel or sheet 73 and 85, respectively, having outer and inner surfaces and are formed in predetermined geometric shapes adapted to fit inside the spring-back frame assembly 12. The panels are preferably constructed of tempered, laminated or otherwise strengthened transparent glass; however, it is noted that other panel materials may be used such as opaque or coated glass, transparent coated or opaque plastic materials, or multi-composite laminates, such as transparent glass and plastic.

As shown in FIG. 8, the panel 73 for the first pane 72 is uniquely shaped with a plurality of sides or edges where the top edge 73a of the panel 73 is “undercut” 73b providing a full seating of the panel 73 in the spring-back frame assembly 12 resisting movement due to shock and vibration when the spring-back frame 12 is closed while still allowing removal of the pane 72 when the spring-back frame 12 is open. A first vertical bar assembly 74 is attached to the outer vertical edge 74a of the panel 73 for the first pane 72 using a silicone sealant. The first vertical bar assembly 74 includes a first vertical bar 76 with a first long weather seal 78 attached to the full length of the outer surface 76a of the vertical bar 76 and a stop pawl 82 mounted to the lower portion of the vertical bar 76 adapted to fit in the spring-back frame as shown in FIGS. 8, 8a and 8b.

As stated above, the first pane 72 is installed in the spring-back frame assembly 12 in a stationary manner where the pane 72 is secured within the frame 12 so that when the spring-back frame 72 is opened or closed the pane 72 remains intact minimizing the likelihood of the panel for the first pane 72 falling and breaking when removed by the operator for cleaning or other related purposes. In the present embodiment, a weather strip 104 is fixed to the spring-back frame assembly where the first pane is installed on top of the weather strip as illustrated in FIG. 3c. In addition, an outer rubber stop 48 is inserted in the second internal guide slot 102b as depicted in FIG. 3d securing the first pane 72 in a stationary manner when installed in the spring-back frame assembly. Finally, an inner rubber track cover is inserted in the entire length of the first internal guide slot in the sub-frame extrusion 61 and in the first internal guide slot for the shorter vertical side 22a of the main frame extrusion 22 as shown in FIG. 3c providing a cover for the first internal guide slot 102a.

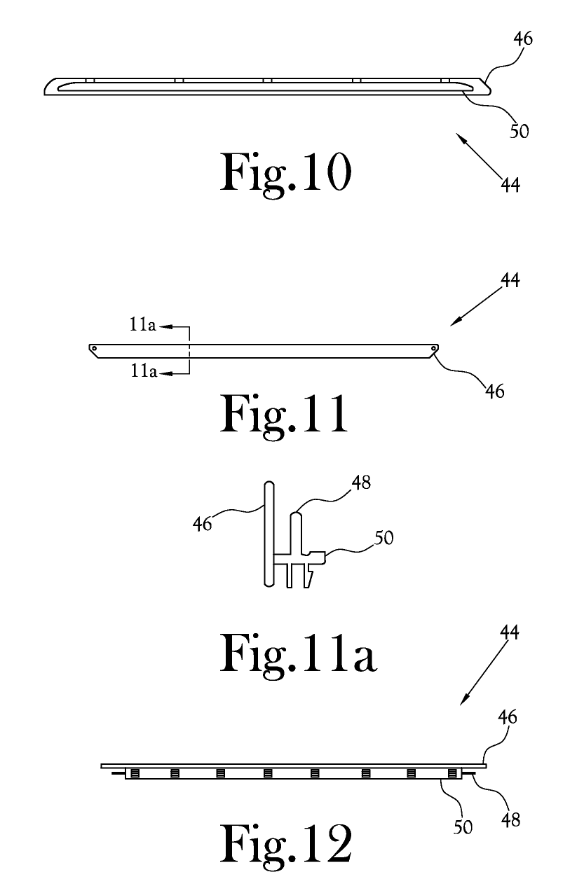

FIG. 9 illustrates the second pane assembly 84 which also includes a uniquely shaped panel 85 with a plurality of sides or edges where a second vertical bar assembly 86 is attached to the outer vertical edge 84a and a horizontal bar assembly 114 is attached the outer horizontal bottom edge 84b. The second vertical bar assembly 86 includes a second vertical bar 88 with a second long weather seal 90 attached to the outer surface 88a of the vertical bar 88. FIGS. 9, 9a and 9b illustrate the horizontal bar assembly 114 which is adapted to fit along the outer horizontal bottom edge 84b of the panel 85 for the second pane assembly 84 permitting the second pane assembly 84 to slide in a longitudinal direction when mounted in the spring-back frame assembly 12. Specifically, a main frame bottom rail assembly 44 is attached on the bottom side 22c of the main frame extrusion 22 securing the lower portion of the second pane 84 within the main frame assembly 20 and permitting the sliding of the pane 84 in the longitudinal direction. FIGS. 10, 11, 11a and 12 depict the main frame bottom guide rail assembly 44 which comprises a main frame rail plate 50, a main frame bottom guide rail 48 and a mainframe guide plate 46. As shown in FIG. 11a, the main frame rail plate 50 is attached to the inside channel member 100 of the bottom side 22c of the main frame extrusion 22 and the main frame bottom guide rail 48 is adapted to the main frame rail plate 50 to secure and permit the second pane 84 to slide in the longitudinal direction along the main frame guide plate 50.

As previously stated, the second pane 84 is moved by the operator using a multi-positionable latch 28 which is attached to the second pane 84 and adjacent to the guide mechanism 30. The pane 84 is moved by an operator by squeezing the short-hand lever 28b into the long-hand lever 28a of the multi-positionable latch 28 thereby allowing the tongue 28c of the multi-positionable latch 28 to retract inward permitting the window 84 to move in a longitudinal direction guided by the guide mechanism 30 which is attached to the pane 84 and the upper inside guide rail 106 of the top side 22d of the main frame extrusion 22 illustrated in FIG. 3e. As shown in FIG. 4, a plurality of latch notch holes 24 are located on the inside guide rails on the top side 22d of the main frame extrusion 22, and are adapted to receive the tongue 28c of the multi-positionable latch 28 as the latch levers 28a and 28b are released by the operator. Once the latch tongue 28c is secured in a corresponding latch notch hole 24, the window 84 is locked into place. A guide cut-out slot 25, also shown in FIG. 4, is also located on the inside guide rail on the top side 22d of the main frame extrusion 22 adapted to receive the guide mechanism 30 when the second pane 84 is in a fully open position.

The first and second panes 72 and 84 may be easily removed from the spring back frame 12 by the operator for cleaning, replacement or other purposes by opening the spring back frame 12. To open the spring back frame 12, the operator uses the spring loaded frame release latch lever 63 to slide the body 62a of the frame release latch 62 out of the guide slot 102a of the top side of the main frame thereby releasing the main frame from the sub-frame. The operator then uses a lift plate 32 which is fastened to the external channel guide slot 102a of the main frame assembly 20 as shown in FIG. 3b to lift the main frame assembly 20 off and over the first pane 72 permitting the easy removal of the pane 72 for cleaning, replacing or other related purposes. The operator can also remove the second pane 84 by sliding the pane 84 in the fully open position and using the lift plate 32 to lift the main frame assembly up and off of the second pane 84 permitting the easy removal of the pane 84 for cleaning, replacing and other related purposes.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A window assembly providing quick and easy removal of panes for cleaning, replacement and other purposes, comprising:
a releasably mounted spring-back frame adapted to hold at least one pane; and
a pane for covering a window opening defined by the spring-back frame.

2. The window assembly in claim 1, further comprising a spring loaded frame release latch for releasing and securing the spring-back frame.

3. The sliding, toollessly removable side window assembly in claim 1, wherein the spring-back frame is formed from extrusions that are joined by the spring loaded frame release latch.

4. A sliding, toollessly removable side window assembly for a vehicle door providing quick and easy removal of panes by the operator for cleaning, replacement and other purposes, comprising:
a releasably mounted spring-back frame mounted to a longitudinal side of vehicle door and adapted to hold a plurality of panes;
a plurality of panes for covering a window opening in the vehicle door which are adapted to fit inside the spring-back frame.

5. The sliding, toollessly removable side window assembly in claim 4, further comprising a spring loaded frame release latch for opening and closing the spring-back frame.

6. The sliding, toollessly removable side window assembly in claim 4, wherein the spring-back frame comprises a main frame and sub-frame that are joined by a bracket assembly and the spring loaded frame release latch.

7. The sliding, toollessly removable side window assembly in claim 4, wherein the main frame and sub-frame are formed from extrusions adapted to hold the plurality of panes.

8. The sliding, toollessly removable side window assembly in claim 7, wherein the main frame and sub-frame extrusions have an outer flange with a plurality of threaded holes located along the perimeter of the flange for fastening the frames to the vehicle.

9. The sliding, toollessly removable side window assembly in claim 4, wherein the plurality of panes includes at least a first pane and a second pane for covering a window opening in the vehicle door.

10. The sliding, toollessly removable side window assembly in claim 9, wherein the first pane is adapted to fit inside the spring-back frame to remain stationary and the second pane is slidably adapted to fit inside the spring-back frame where the pane can slide in the longitudinal direction.

11. The sliding, toollessly removable side window assembly in claim 9, wherein the first and second pane comprise a panel or sheet of glass having inner and outer surfaces and peripheral edge configured to fit inside the spring-back frame within the vehicle body and include a top and bottom edge and a plurality of side edges where at least the top edge of the first pane is undercut allowing the first pane to be fully seated in the spring-back frame when the frame is in the closed position and providing clearance to tilt the pane for removal when the frame is in the open position.

12. The sliding, toollessly removable side window in claim 4, further comprising a lift plate fastened to the main frame for use during the removal of the panes.

13. The sliding, toollessly removable side window assembly in claim 4, further comprising a multi-positionable latch and guide mechanism attached to the second pane permitting the operator to open and close the second pane and to lock it into place during the vehicle's use.

14. A method for removing panes installed in a sliding, toollessly removable-side window for a vehicle for cleaning, replacing and other related purposes comprising the steps of:
providing a sliding, toollessly removable side window for a vehicle comprising a spring-back frame assembly with a first and second pane installed which includes a main frame and sub-frame where the main frame and sub-frame are joined by a spring loaded frame release latch and a corner bracket assembly;
opening the spring-back frame assembly by sliding the spring loaded frame release latch back releasing the sub-frame from the main frame;
while the sub-frame is released from the main frame, using a lift plate attached to the spring-back frame assembly to lift the main frame up and off of the first pane providing the necessary clearance between the installed first and second pane to remove the first pane from the spring-back frame assembly;
while the sub-frame is released from the main frame, sliding the second pane to fully open position using the multi-positionable latch and guide mechanism and using the lift plate to lift the main frame up and off of the second pane providing the necessary clearance to remove the second pane from the spring-back frame assembly.
